(19) United States
(12) Patent Application Publication
(10) Pub. No.: US 2023/0177830 A1
(43) Pub. Date: Jun. 8, 2023

(54) PLANT GROWTH IDENTIFICATION METHOD AND SYSTEM THEREFOR

(71) Applicant: AGROMEANS CO., LTD., EDEN ISLAND (SC)

(72) Inventor: CHIH-HAO WEI, HSINCHU CITY (TW)

(21) Appl. No.: 17/998,399

(22) PCT Filed: May 14, 2020
(86) PCT No.: PCT/CN2020/090149

§ 371 Date: Nov. 10, 2022

(51) Int. Cl. G06V 20/10; G06T 7/62; G06V 10/766; H04N 7/18; G06T 7/80; H04N 17/00; G06V 10/44; A01G 7/04; A01G 9/24

(52) U.S. Cl. CPC G06V 20/188; G06T 7/62; G06V 10/766; H04N 7/183; G06T 7/80; H04N 17/002; G06V 10/44; A01G 7/045; A01G 9/249; G06T 2207/30244; G06T 2207/30188

(57) ABSTRACT

The present invention relates to a plant growth identification method and a system therefor. At least one photographing unit transmits a picture captured thereby to a control unit so as to calculate the pixel distance per unit, and then the photographing unit captures a picture of a plant so that features points of the plant such as buds, flowers, or fruits in the captured picture are identified with the control unit, the pixel distance of each feature point and the height thereof are then calculated with the control unit, and the number and area of the multiple feature points are counted so as to calculate the growth rate and yield of the plant. Moreover, data such as growth height, rate and yield of the plant is regularly updated so as to dynamically adjust the light intensity of a lighting unit on the plant.

### BACKGROUND OF THE INVENTION

### Field of the Invention

The present invention relates to a plant growth identification method and a system therefor, in particular to a method and a system for automatically cultivating plants to effectively save labor costs and lighting energy consumption, and improve plant yield and quality.

### Description of Related Art

It is noted that the cultivation of plants will be affected by factors such as temperature, sunlight, water and other natural environment and climate, so problems such as poor plant growth are prone to occur. In order to reduce the influence of natural environment and climate on plant growth, greenhouse cultivation and indoor cultivation methods have gradually been paid more and more attention.

One of the major factors affecting plant growth is the quantity of light. Therefore, in general greenhouse cultivation and indoor cultivation, artificial light sources are often used to imitate the effect of sunlight, so as to facilitate the photosynthesis of the plants. However, the distance between the artificial light source and the plant will directly affect the photosynthesis of the plant. If the distance between the light source and the plant is too long, the light intensity will be insufficient, which will reduce the photosynthesis of the plant. On the contrary, if the distance between the light source and the plant is too short, the light intensity will increase, which will also affect the growth of the plant and cause adversity. Nevertheless, the conventional adjustment of the illumination intensity and irradiation time of artificial light sources still relies on personal experiences to judge, so that in addition to being unable to precisely control and easily causing improper energy consumption, it also takes a lot of manpower and time to go to the greenhouse to take care of each plant every day to adjust the light conditions suitable for its growth, resulting in a waste of labor costs and man-hours. In addition, the current harvesting time and yield of plants can only be estimated based on personal experiences, so the problem of inaccurate harvesting estimation is prone to occur. When the harvest estimation is inaccurate, it will affect the quality and yield, resulting in a decline in economic value or improper fluctuations in market prices, affecting farmers' income and the development of the market economy.

In view of the many drawbacks caused by the conventional plant cultivation relying on manpower and personal experience, the present inventor has developed the present invention with the assistance of his years of manufacturing and design experience and knowledge in related fields, and through ingenuity.

### SUMMARY OF THE INVENTION

The present invention relates to a plant growth identification method and a system thereof, which main purpose is to use deep photography combined with artificial intelligence to learn and identify plant characteristics, so as to improve the accuracy of the estimation of plant growth rate and yield; another purpose is to improve the accuracy of the spectrum and light intensity of the light source irradiating plants, so as to save lighting energy consumption and improve plant yield and quality.

In order to achieve the above-mentioned objects, the present inventor has developed the following plant growth identification system, including:

at least one fixed unit, wherein the fixed unit is erected in a plant growing area;

at least one photographing unit, wherein the photographing unit is assembled on the fixed unit; and

at least one control unit, wherein the control unit is connected with the photographing unit through wired or wireless signals, and the control unit has an artificial intelligent program for plant growth identification loaded therein, wherein the artificial intelligent program for plant growth identification comprises a unit pixel distance calculation module, a feature point learning and identification module, a feature point pixel distance calculation module, a feature point height calculation module, a feature point area calculation module, a feature point totaling module, and a plant growth rate and yield calculation module arranged therein, allowing the control unit to connect and operate the modules of the artificial intelligent program for plant growth identification.

According to the above plant growth identification system, the plant growth identification system further comprises at least one lighting unit, wherein the lighting unit is assembled on the fixed unit, and the control unit and the lighting unit are connected through wired or wireless signals, wherein the artificial intelligent program for plant growth identification further comprises a dynamic lighting adjustment module arrange therein, so that the control unit is interactively connected with the lighting unit through the dynamic lighting adjustment module.

The present inventor further developed the following plant growth identification method, includes the steps of:

A. positioning photographing unit: facing the lens of at least one photographing unit downward, and keeping the lens horizontal so as to be perpendicular to the ground, and fixing the height position thereof;

B. calculating the unit pixel distance: transmitting the photographing picture taken by the photographing unit to a control unit connected therewith, and then calculating the actual distance represented by each unit pixel in the photographing picture of the photographing unit with the control unit;

C. capturing the feature points: photographing the plant below the photographing unit therewith, and transmitting the photographing picture to the control unit so as to identify the feature points of the bud, flower or fruit of the plant in the photographing picture with the control unit, and then mark the position and the area size of the feature point with a box respectively;

D. calculating the feature point pixel distance: multiplying the pixel distance of each feature point box captured with the control unit by the distance per unit pixel obtained in step B so as to calculate and obtain the actual distance of each feature point pixel;

E. calculating the feature point height: combining the pixel distance of each feature point obtained in the step D with trigonometric calculation with the control unit to obtain the height of each feature point;

F. calculating the feature point area: multiplying the length and width of each feature point pixel obtained in step D with the control unit to obtain the projected area of each feature point, and then converting the area ratio with the projected area of each feature point and the height of each feature point obtained in step E to obtain the actual area of each feature point;

G. totaling the number and area of the feature points: totaling the number of several feature points of the plants captured by the photographing unit, and totaling the area of the feature points through the control unit;

H. calculating the growth rate and yield: calculating the yield of each feature point of the plant photographed by the photographing unit by the area and yield regression formula, and calculating the growth rate of each feature point of the plant photographed by the photographing unit by the growth rate formula with the control unit.

According to the above plant growth identification method, the plant growth identification method further comprises a step of regularly updating the plant growth data after the step of calculating the growth rate and yield: driving the photographing unit to upload the photographing picture to the control unit at a fixed time with the control unit, so as to enable the control unit to calculate the growth height, growth rate and yield of the plants photographed by the photographing unit at each fixed time.

According to the above plant growth identification method, the plant growth identification method further comprises a step of dynamically modulating light intensity after the step of regularly updating the plant growth data: dynamically modulating the spectrum and the light intensity of the plant below the lighting unit connected with the control unit according to the plant growth height, growth rate and yield data obtained at each fixed time with the control unit.

According to the above plant growth identification method, the step of calculating the unit pixel distance further comprises: making the photographing unit photograph a subject on the ground, and then transmitting the photographing picture of the subject to the control unit, and calculating the length and width of the subject by using the formula of x=(a×z)/f and y=(b×z)/f loaded in the control unit, wherein x is the length of the subject, y is the width of the subject, a is the length of a photosensitive element built in the photographing unit, b is the width of the photosensitive element built in the photographing unit, f is the focal length of the photographing unit, z is the vertical distance from the photographing unit to the ground, and the vertical distance z from the photographing unit to the ground is obtained by the measuring of the photographing unit, and then capturing the parameters of the length a, width b and focal length f of the photosensitive element of the photographing unit with the control unit, which are substituted into the x=(a×z)/f and y=(b×z)/f formula to calculate the length and width of the subject, wherein the length and width of the subject are then divided by the pixel resolution of the photographing unit to obtain the actual distance represented by each unit pixel in the photographing picture of the photographing unit.

According to the above plant growth identification method, the step of calculating the unit pixel distance further comprises: placing a calibration label with a known length and width on the ground, and then photographing the calibration label with the photographing unit, transmitting the photographing picture of the calibration label to the control unit, measuring the pixels occupied by the calibration label in the photographic image with the control unit, and then dividing the length and width of the calibration label by the pixels occupied by the calibration label in the photographing picture respectively so as to obtain the actual distance represented by each unit pixel in the photographing picture of the photographing unit.

According to the above plant growth identification method, the step of calculating the feature point height further comprises: calculating the feature point height of each plant with the control unit uses the triangular formula of e²=z²+c² loaded thereof, wherein z is the vertical distance from the photographing unit to the ground, c is the feature point pixel distance, e is the distance from the projection of the photography unit to the ground through the feature points of plants, the vertical distance z from the photographing unit to the ground is obtained by the measuring of the photographing unit, and the feature point pixel distance c is obtained by the D step, and then substituting the known vertical distance z from the photographing unit to the ground and the pixel distance c of the feature point into the formula of e²=z²+c² to calculate and obtain the distance e of the photographing unit projected from the plant feature point to the ground, and then using the formula of h=z×(e−d)/d loaded in the control unit, wherein z is the vertical distance from the photographing unit to the ground, e is the distance from the photographing unit projected to the ground by the plant feature points, d is the distance from the photography unit to the plant feature point, h is the height of the feature point, and the distance d from the photographing unit to the plant feature point is obtained by the measuring of the photographing unit, wherein the known vertical distance z from the photographing unit to the ground, the distance e from the photographing unit projected to the ground through the plant feature point, and the distance d from the photographing unit to the plant feature point are substituted into the h=z×(e−d)/d to obtain the feature point height h.

According to the above plant growth identification method, wherein in the step of calculating the feature point area, calculating the actual area of the feature point with the control unit uses the area conversion formula of a=s×[(z−h)/z]² loaded thereof, wherein a is the feature point area, s is the feature point projected area, z is the vertical distance from the camera unit to the ground, h is the feature point height, the feature point projected area s is multiplied by the pixel length and width distance of the feature points obtained in step D, the vertical distance z from the photographing unit to the ground is obtained by the measuring of the photographing unit, the feature point height h is obtained in step E, wherein the known feature point projected area s, the vertical distance z from the photographing unit to the ground and the feature point height h are substituted into the formula of a=s×[(z−h)/z]² to obtain the feature point area a.

According to the above plant growth identification method, the plant growth identification method further comprises a step of depth calibrating the photographing unit, which is to perform the step of depth calibrating the photographing unit after the positioning photographing unit in step A, the depth calibrating the photographing unit method:

measuring the distance z1 between the photographing unit and the ground with the photographing unit, and tape measuring the distance z2 between the photographing unit and the ground, and then inputting the values of the z1 and z2 into the photographing unit or the control unit, and after calculating the ratio of z2/z1 by the photography unit or the control unit, self-correcting the proportional error of the depth measurement of the photography unit;

or measuring the distance z between the photographing unit and the ground, and placing a calibration label with a known height h on the ground, and measuring the distance d between the photographing unit and the calibration label by the photographing unit, and then inputting the values of the z, h and d into the photographing unit or the control unit, and after calculating the ratio of height h/(z−d) with the photographing unit or the control unit, self-correcting the proportional error of the depth measurement of the photography unit.

Thereby, with the plant growth identification method and system thereof of the present invention, the growth rate and yield of the cultivated plant can be accurately estimated, so as to facilitate the maintenance of the development of the market economy. Also, the present invention enables precisely control of the light intensity of the plant by dynamic modulation of the lighting unit, which avoids the situation that the light intensity is insufficient or too strong due to artificial experience judgment, thereby preventing improper energy consumption and enhancing the yield and growth quality of plants. In addition, the present invention adopts automatic cultivation of plants, so as to make benefits in effectively saving labor cost, man-hour expenditure for taking care of plants, and etc.

### BRIEF DESCRIPTION OF THE DRAWINGS

FIG. 1 is a front view of the present invention.

FIG. 2 is a system architecture view of the present invention.

FIG. 3 is a flow diagram of the present invention.

FIG. 4 is a perspective view of a depth calibration of a photographing unit according to the present invention.

FIG. 5 is a perspective view of a first unit pixel distance calculation according to the present invention.

FIG. 6 is a perspective view of a second unit pixel distance calculation according to the present invention.

FIG. 7 is a perspective view of a feature point capture according to the present invention.

FIG. 8 is a perspective view of a feature point height calculation according to the present invention.

FIG. 9 is a perspective view of a feature point area calculation according to the present invention.

### DETAILED DESCRIPTION OF THE PREFERRED EMBODIMENT

In order to have a more complete and clear disclosure of the technical content of the present invention, and the effect achieved thereby, the disclosure is explained in detail below with the references of the drawings and drawing numbers:

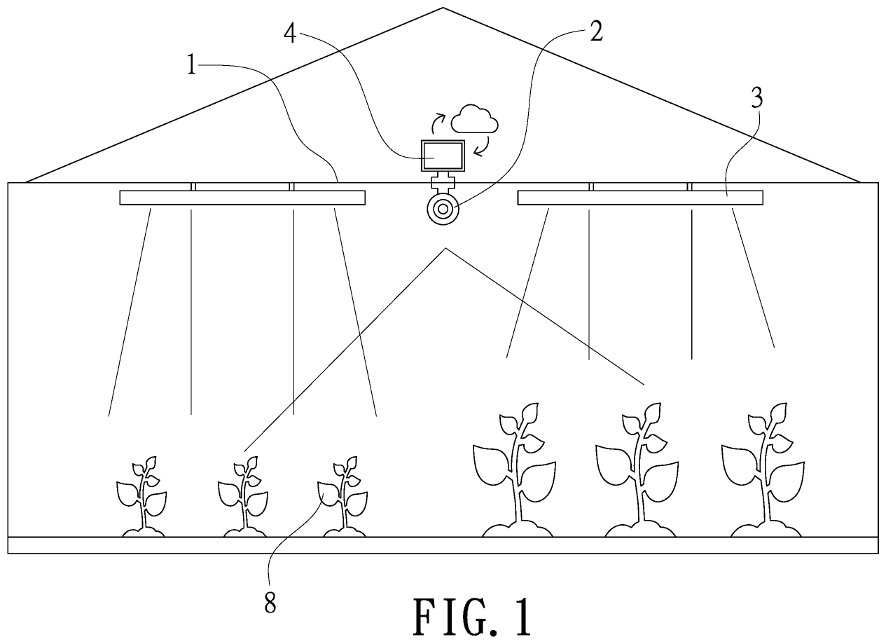

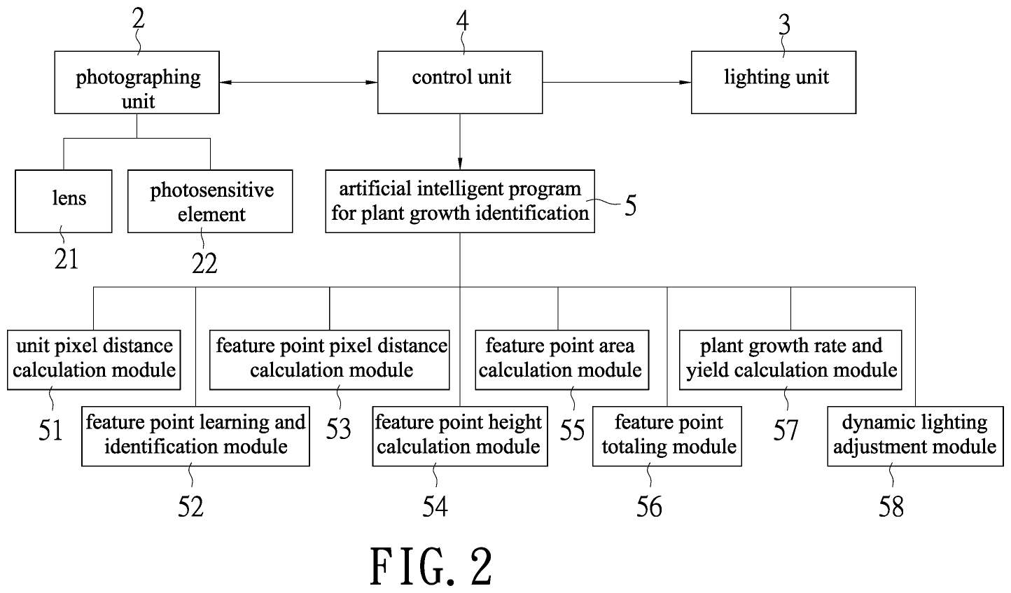

Referring to FIGS. 1 and 2, a plant growth identification system according to the present invention includes:

at least one fixed unit 1, wherein the fixed unit 1 may be a bracket to be erected in a plant growing area;

at least one photographing unit 2, wherein the photographing unit 2 is arranged on the fixed unit 1, wherein the photographing unit 2 is a depth camera, wherein the photographing unit 2 has a depth measurement program loaded therein, wherein the photographing unit 2 comprises two RGB lenses 21 arranged thereon, and a photosensitive element 22 arranged therein;

at least one lighting unit 3, wherein the lighting unit 3 is assembled on the fixed unit 1 and located above the photographing unit 2, wherein the lighting unit 3 may be an LED lamp; and

at least one control unit 4, wherein the control unit 4 can be a desktop computer or a laptop computer, etc., wherein the control unit 4 is connected with the photographing unit 2 and the lighting unit 3 through wired or wireless signals, such as 3G, 4G, Wi-Fi, Bluetooth, and etc., wherein the control unit 4 has an artificial intelligent program for plant growth identification 5 loaded therein, wherein the artificial intelligent program for plant growth identification 5 includes a unit pixel distance calculation module 51, a feature point learning and identification module 52, a feature point pixel distance calculation module 53, a feature point height calculation module 54, a feature point area calculation module 55, a feature point totaling module 56, a plant growth rate and yield calculation module 57, and a dynamic lighting adjustment module 58 arranged therein, wherein the control unit 4 is connected with the artificial intelligent program for plant growth identification 5 to operate each of the modules.

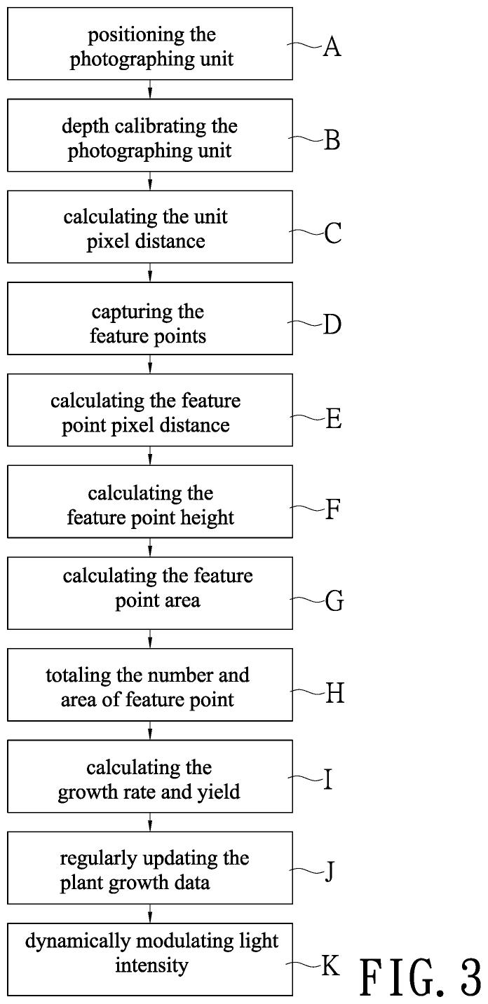

Accordingly, when the present invention is implemented, referring to FIG. 3, the method includes the steps of:

A. positioning the photographing unit: fixing the photographing unit 2 at a height position of the fixed unit 1, and facing the lens 21 of the photographing unit 2 downward and keeping the lens 21 horizontal so as to be perpendicular to the ground;

B. depth calibrating the photographing unit: comprising two methods:

method 1: measuring the distance z1 between the photographing unit 2 and the ground by the photographing unit 2, tape measuring the distance z2 between the photographing unit 2 and the ground, and then inputting the values of z1 and z2 into the photographing unit 2 or controls unit 4, and after calculating the ratio of z2/z1 by the depth measurement program built in the photographing unit 2 or the control unit 4, self-correcting the ratio error of the depth measurement of the photographing unit 2;

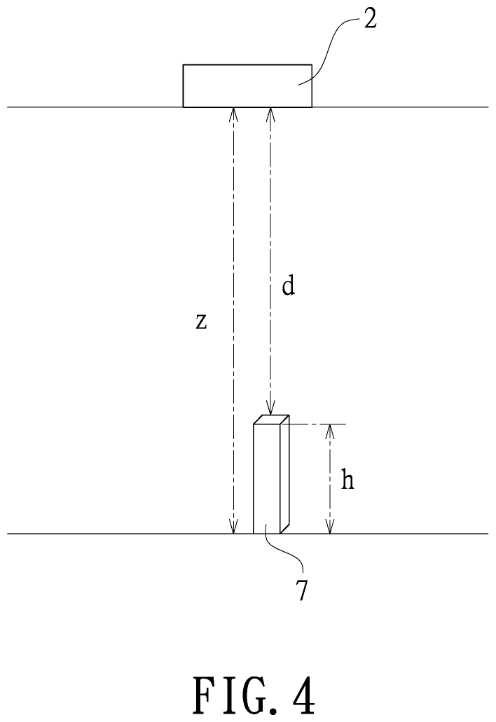

referring to FIG. 4, method 2: measuring the distance z between the photographing unit 2 and the ground by the photographing unit 2, placing a calibration label 7 with a known height h on the ground, measures the distance d between the photographing unit 2 and the calibration label 7 by the photographing unit 2, and then inputting the values of z, h and d into the photographing unit 2 or the control unit 4, and after calculating the ratio of h/(z−d) by the depth measurement program built in the photographing unit 2 or the control unit 4, self-correcting the ratio error of the depth measurement of the photographing unit 2;

C. calculating the unit pixel distance: comprising two methods:

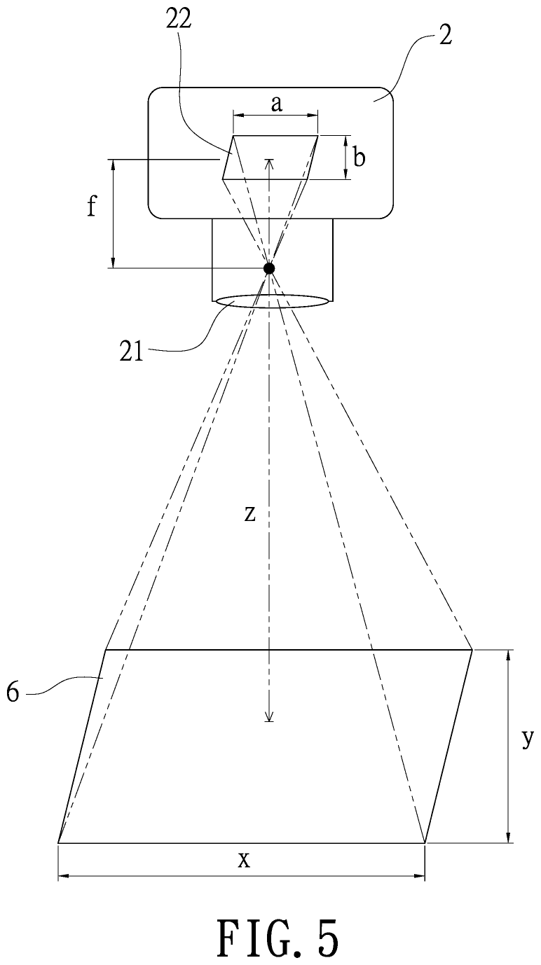

referring to FIG. 5, method 1: photographing any subject 6 on the ground with the photographing unit 2, and then transmitting the photographing picture of the subject 6 to the control unit 4, and calculating the length and width of subject 6 with the control unit 4 by using the formulas of x=(a×z)/f and y=(b×z)/f preset by the unit pixel distance calculation module 51 loaded in the artificial intelligent program for plant growth identification 5, wherein x is the length of the subject 6, y is the width of the subject 6, a is the length of the photosensitive element 22 of the photographing unit 2, b is the width of the photosensitive element 22 of the photographing unit 2, f is the focal length of the photographing unit 2, z is the vertical distance from the photographing unit 2 to the ground, and the vertical distance z from the photographing unit 2 to the ground is obtained by measuring the photographing unit 2 by itself, and capturing the parameters such as the length a, the width b and the focal length f of the photosensitive element 22 of the photographing unit 2 with the unit pixel distance calculation module 51, substituting these parameters into the aforementioned x=(a×z)/f and y=(b×z)/f formula to calculate the length x and width y of the subject 6, and then dividing the length x and width y of the subject 6 by the pixel resolution of the photographing unit 2, so as to obtain the actual distance represented by each unit pixel in the photographing picture of the photographing unit 2;

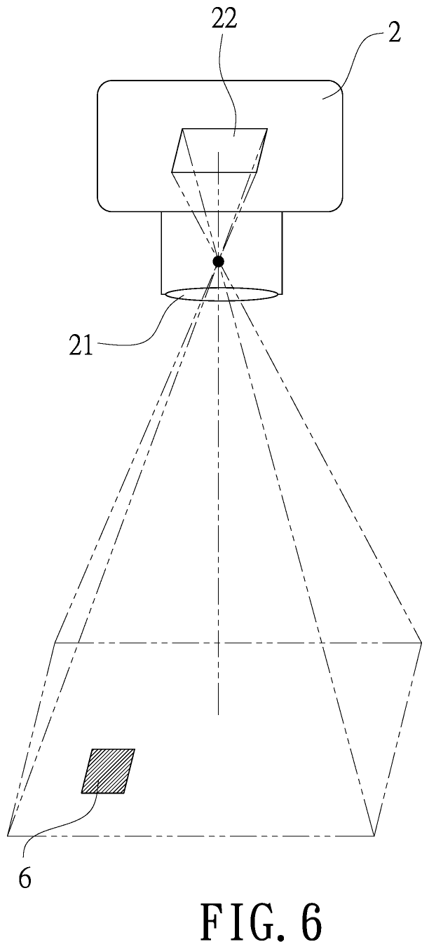

in addition, referring to FIG. 6, method 2: placing a calibration label 7 with a known length and width on the ground, and photographing the calibration label 7 with the photographing unit 2, and then transmitting the photographing picture of the calibration label 7 to the control unit 4, allowing the unit pixel distance calculation module 51 to measure the pixels occupied by the calibration label 7 in the photographing picture, and then dividing the length and width of the calibration label 7 by the pixels occupied by the calibration label 7 in the photographing picture, so as to obtain the actual distance represented by each unit pixel in the photographing picture of the photographing unit 2;

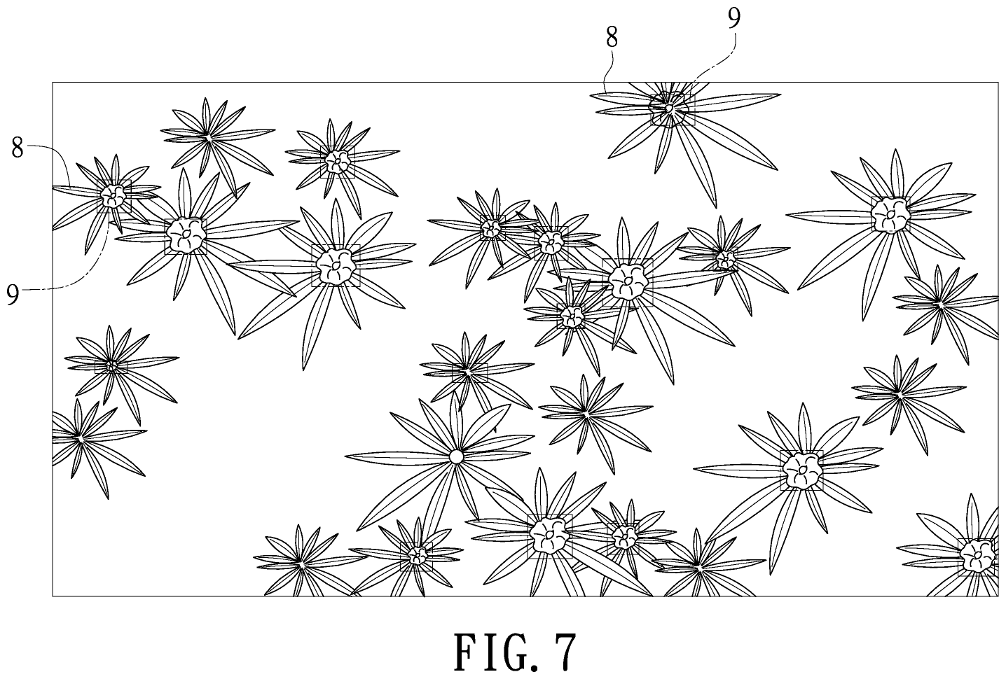

D. capturing the feature points: referring to FIG. 7, photographing plants 8 below the photographing unit 2 therewith, and then transmitting the photographing picture to the control unit 4, so that the control unit 4 drives the feature point learning and identification module 52 loaded in the artificial intelligent program for plant growth identification 5 to identify the feature points such as the bud, flower or fruit of the plants 8 in the photographing picture, and to mark the position and area size of the feature point with a box 9 respectively;

E. calculating the feature point pixel distance: driving the control unit 4 to utilize the feature point pixel distance calculation module 53 loaded in the artificial intelligent program for plant growth identification 5 to multiply the pixel distance of each feature point box 9 captured by the feature point learning and identification module 52 by the distance per unit pixel obtained in the step C so as to calculate and obtain the actual distance of each feature point pixel;

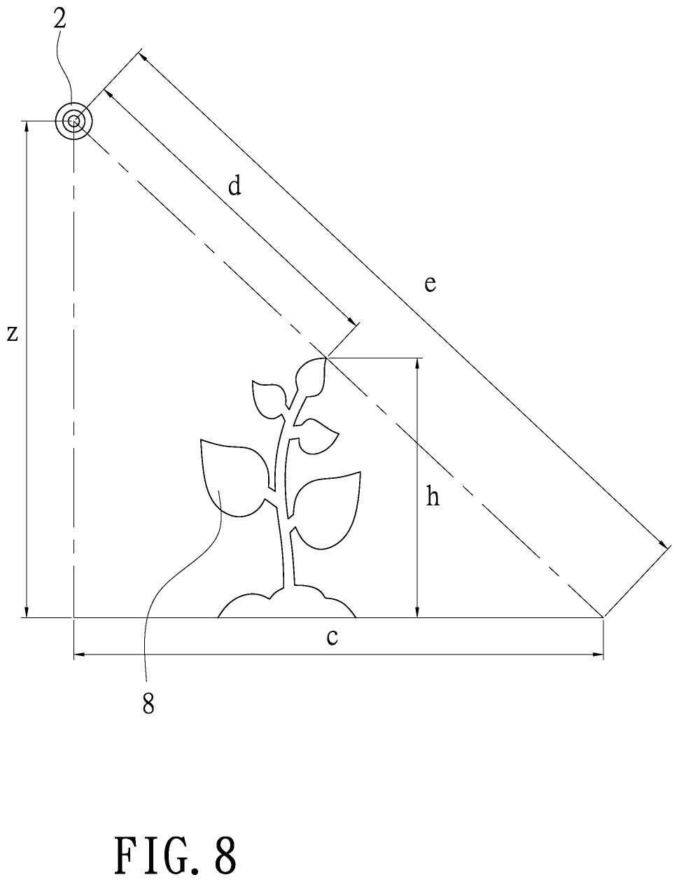

F. calculating the feature point height: referring to FIG. 8, driving the control unit 4 to use the feature point height calculation module 54 loaded in the artificial intelligent program for plant growth identification 5 to preset a triangular formula of e²=z²+c² to calculate the feature point height of each plant 8, wherein z is the vertical distance from the photographing unit 2 to the ground, c is the feature point pixel distance, e is the distance from the photographing unit 2 projected from the feature point of the plant 8 to the ground, the vertical distance z from the photographing unit 2 to the ground can be obtained by measuring the photographing unit 2 by itself, and the feature point pixel distance c is obtained in step E, and then substituting the known vertical distance z from the photographing unit 2 to the ground and the feature point pixel distance c into the formula of e²=z²+c² to calculate and obtain the distance e of the photographing unit 2 projected from the feature point of the plant 8 to the ground, and then continuously using the formula h=z×(e−d)/d preset by the feature point height calculation module 54, wherein z is the vertical distance from the photographing unit 2 to the ground, e is the distance from the photographing unit 2 projected to the ground through the feature point of the plant 8, d is the distance from the photographing unit 2 to the feature point of the plant 8, h is the height of the feature point, and the distance d from the photographing unit 2 to the feature point of the plant 8 can be obtained by the photographing unit 2 by its own measurement, and then substituting the known vertical distance z from the photographing unit 2 to the ground, the distance e of the photographing unit 2 projected from the feature point of the plant 8 to the ground and the distance d from the photographing unit 2 to the feature point of the plant 8 into the formula of h=z×(e−d)/d to obtain the feature point height h;

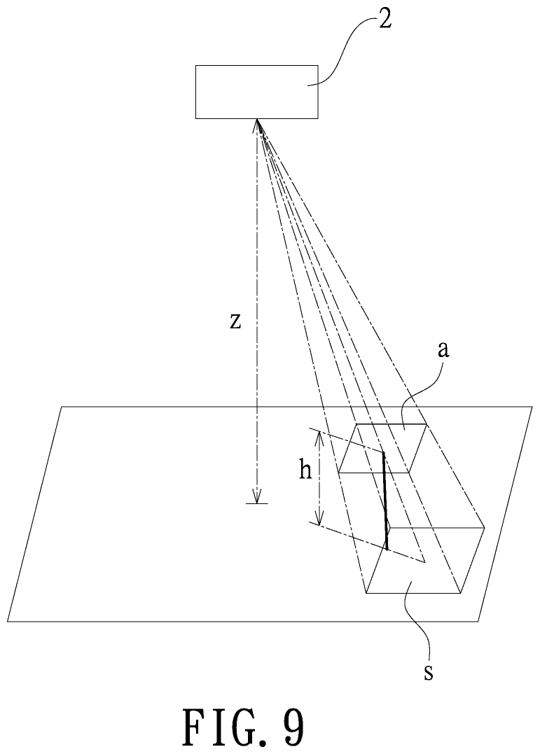

G. calculating the feature point area: referring to FIG. 9, calculating the actual area of the feature point with the control unit 4 through the area conversion formula of a=s×[(z−h)/z]² preset by the feature point area calculation module 55 loaded in the artificial intelligent program for plant growth identification 5, wherein a is the area of the feature point, s is the projected area of the feature point, z is the vertical distance from the photographing unit 2 to the ground, h is the height of the feature point, the projected area s of the feature point is to multiply the pixel length and width distance of the feature point obtained in step E, the vertical distance z from the photographing unit 2 to the ground can be obtained by the photographing unit 2 by its own measurement, and the height h of the feature point is obtained in step F, wherein the known feature point projected area s, the vertical distance z from the photographing unit 2 to the ground, and the feature point height h are substituted into the formula of a=s×[(z−h)/z]² to calculate the feature point area a;

H. totaling the number and area of feature points: driving the control unit 4 to utilize the feature point totaling module 56 loaded in the artificial intelligent program for plant growth identification 5 to total the numbers and areas of a plurality of the feature points of the plants 8 captured by the photographing unit 2;

I. calculating the growth rate and yield: calculating the yield of the plants 8 photographed by the photographing unit 2 with the control unit 4 through a preset area and yield regression formula of the plant growth rate and yield calculation module 57 loaded in the artificial intelligent program for plant growth identification 5, wherein the area and yield regression formula is collected through experiments, which is the actual yield obtained by collecting the area of several feature points, and then summing up the areas and yields of the feature points to calculate the average yield value per unit feature point area, so as to deduce the area and yield regression formula, wherein the growth rate of the plant 8 may also be obtained through experimental collection by observing the time required for the feature points such as buds, flowers or fruits of the plants 8 photographed by the photographing unit 2 from planting to germination, or from flower bud to flowering, or from flowering to bearing fruit, so that the growth rate formula of the various feature points such as the buds, flowers or fruits can be deduced, and then the growth rate of each feature point of the plant 8 photographed by the photographing unit 2 can be calculated through the growth rate formula;

J. regularly updating the plant growth data: driving the photographing unit 2 to upload the photographing picture to the control unit 4 at a fixed time with the control unit 4, so as to allow the modules of the artificial intelligent program for plant growth identification 5 of the control unit 4 to repeat the aforementioned steps to calculate the growth height, growth rate and yield of the plants 8 photographed by the photographing unit 2 at each fixed time.

K. dynamically modulating light intensity: dynamically modulating the spectrum and light intensity of the plant 8 below the light unit 3 connected thereto according to the growth height, rate and yield data of the plants 8 obtained at each fixed time by means of the dynamic lighting adjustment module 58 loaded in the artificial intelligent program for plant growth identification 5 of the control unit 4, so that when the growth height of the plant 8 is low, the irradiation intensity will be increased, and when the growth height of the plant 8 is higher, the irradiation intensity will be relatively reduced, so as to optimize the cultivation of the plant 8 and save energy consumption.

Thereby, with the plant growth identification method and system thereof of the present invention, the growth rate and yield of the cultivated plant 8 can be accurately estimated, so as to avoid inappropriate fluctuations in the market prices and to maintain the development of the market economy. In addition, the present invention enables the artificial intelligent program for plant growth identification 5 loaded in the control unit 4 can accurately control the lighting unit 3 to dynamically adjust the light intensity of the plants 8 according to the data of the height, growth rate and yield of the feature points of the plants 8 photographed by the photographing unit 2, such as buds, flowers or fruits, etc., so as to avoid the situation that the light intensity is insufficient or too strong based on artificial judgment and personal experience, and facilitate the photosynthesis of plants 8. Accordingly, the present invention can improve the yield and growth quality of plants 8 in addition to preventing improper consumption of energy. Besides, the present invention adopts automatic cultivation of plants 8, so the labor cost and man-hour expenditure of caring for the plants 8 can be effectively saved, so as to facilitate the enhancement of industrial competitiveness.

What is claimed is:

1. A plant growth identification system, comprising:
at least one fixed unit, wherein the fixed unit is erected in a plant growing area;
at least one photographing unit, wherein the photographing unit is assembled on the fixed unit; and
at least one control unit, wherein the control unit is connected with the photographing unit through wired or wireless signals, and the control unit has an artificial intelligent program for plant growth identification loaded therein, wherein the artificial intelligent program for plant growth identification comprises a unit pixel distance calculation module, a feature point learning and identification module, a feature point pixel distance calculation module, a feature point height calculation module, a feature point area calculation module, a feature point totaling module, and a plant growth rate and yield calculation module arranged therein, allowing the control unit to connect and operate the modules of the artificial intelligent program for plant growth identification.

2. The plant growth identification system as claimed in claim 1, the plant growth identification system further comprises at least one lighting unit, wherein the lighting unit is assembled on the fixed unit, and the control unit and the lighting unit are connected through wired or wireless signals,
wherein the artificial intelligent program for plant growth identification further comprises a dynamic lighting adjustment module, so that the control unit is interactively connected with the lighting unit through the dynamic lighting adjustment module.

3. A plant growth identification method, comprising the steps of:
A. positioning the photographing unit: facing a lens of at least one photographing unit downward, and keeping the lens horizontal so as to be perpendicular to the ground, and fixing a height position thereof;
B. calculating the unit pixel distance: transmitting a photographing picture taken by the photographing unit to a control unit connected therewith, and then calculating an actual distance represented by each unit pixel in the photographing picture of the photographing unit with the control unit;
C. capturing the feature points: photographing plants below the photographing unit, and transmitting a photographing picture to the control unit so as to identify the feature points of the bud, flower or fruit of the plant in the photographing picture with the control unit, and then mark the position and the area size of the feature point with a box respectively;
D. calculating the feature point pixel distance: multiplying the pixel distance of each feature point box captured with the control unit by the distance per unit pixel obtained in step B so as to calculate and obtain the actual distance of each feature point pixel;
E. calculating the feature point height: combining the pixel distance of each feature point obtained in the step D with trigonometric calculation with the control unit to obtain the height of each feature point;
F. calculating the feature point area: multiplying a length and a width of each feature point pixel obtained in step D with the control unit to obtain a projected area of each feature point, and then converting the area ratio with the projected area of each feature point and the height of each feature point obtained in step E to obtain the actual area of each feature point;
G. totaling the number and area of the feature points: totaling the number of several feature points of the plants captured by the photographing unit, and totaling the area of the feature points through the control unit;
H. calculating the growth rate and yield: calculating the yield of each feature point of the plant photographed by the photographing unit through an area and yield regression formula, and calculating the growth rate of each feature point of the plant photographed by the photographing unit through a growth rate formula with the control unit.

4. The plant growth identification method as claimed in claim 3, wherein the plant growth identification method further comprises a step of regularly updating the plant growth data after the step of calculating the growth rate and yield: driving the photographing unit to upload the photographing picture to the control unit at a fixed time with the control unit, so as to enable the control unit to calculate the growth height, growth rate and yield of the plants photographed by the photographing unit at each fixed time.

5. The plant growth identification method as claimed in claim 4, wherein the plant growth identification method further comprises a step of dynamically modulating light intensity after the step of regularly updating the plant growth data: dynamically modulating the spectrum and the light intensity of the plant below the lighting unit connected with the control unit according to the plant growth height, growth rate and yield data obtained at each fixed time with the control unit.

6. The plant growth identification method as claimed in claim 3, wherein the step of calculating the unit pixel distance further comprises: photographing a subject on the ground with the photographing unit, and then transmitting the photographing picture of the subject to the control unit, and calculating the length and width of the subject by using the formula of x=(a×z)/f and y=(b×z)/f loaded in the control unit, wherein x is the length of the subject, y is the width of the subject, a is the length of a photosensitive element built in the photographing unit, b is the width of the photosensitive element built in the photographing unit, f is the focal length of the photographing unit, and z is the vertical distance from the photographing unit to the ground, wherein the vertical distance (z) from the photographing unit to the ground is obtained by the measuring of the photographing unit, and the parameters of the length (a), width (b) and focal length (f) of the photosensitive element of the photographing unit is captured by the control unit, wherein the parameters are substituted into the formula of x=(a×z)/f and y=(b×z)/f to calculate the length and width of the subject, and then the length and width of the subject are divided by the pixel resolution of the photographing unit so as to obtain the actual distance represented by each unit pixel in the photographing picture of the photographing unit.

7. The plant growth identification method as claimed in claim 3, wherein the step of calculating the unit pixel distance further comprises: placing a calibration label with a known length and width on the ground, and then photographing the calibration label with the photographing unit, transmitting the photographing picture of the calibration label to the control unit, measuring the pixels occupied by the calibration label in the photographic image with the control unit, and then dividing the length and width of the calibration label by the pixels occupied by the calibration label in the photographing picture respectively so as to obtain the actual distance represented by each unit pixel in the photographing picture of the photographing unit.

8. The plant growth identification method as claimed in claim 3, wherein the step of calculating the feature point height further comprises: calculating the feature point height of each plant with the control unit by means of the triangular formula of e²=z²+c² loaded therein, wherein z is the vertical distance from the photographing unit to the ground, c is the feature point pixel distance, e is the distance from the projection of the photography unit to the ground through the feature points of plants, the vertical distance (z) from the photographing unit to the ground is obtained by measuring of the photographing unit, and the feature point pixel distance (c) is obtained by the D step, and then substituting the known vertical distance (z) from the photographing unit to the ground and the pixel distance (c) of the feature point into the formula of e²=z²+c² to calculate and obtain the distance (e) of the photographing unit projected from the plant feature point to the ground, and then using the formula of h=z×(e−d)/d loaded in the control unit, wherein z is the vertical distance from the photographing unit to the ground, e is the distance from the photographing unit projected to the ground by the plant feature points, d is the distance from the photography unit to the plant feature point, h is the height of the feature point, and the distance (d) from the photographing unit to the plant feature point is obtained by the of measuring the photographing unit, wherein the known vertical distance (z) from the photographing unit to the ground, the distance (e) from the photographing unit projected to the ground through the plant feature point, and the distance (d) from the photographing unit to the plant feature point are substituted into the h=z×(e−d)/d so as to obtain the feature point height (h).

9. The plant growth identification method as claimed in claim 3, wherein the step of calculating the feature point area further comprises: calculating the actual area of the feature point with the control unit by means of the area conversion formula of a=s×[(z−h)/z]² loaded thereof, wherein a is the feature point area, s is the feature point projected area, z is the vertical distance from the camera unit to the ground, h is the feature point height, the feature point projected area (s) is multiplied by the pixel length and width distance of the feature points obtained in step D, the vertical distance (z) from the photographing unit to the ground is obtained by the measuring of the photographing unit, and the feature point height (h) is obtained in step E, wherein the known feature point projected area (s), the vertical distance (z) from the photographing unit to the ground, and the feature point height (h) are substituted into the formula of a=s×[(z−h)/z]² so as to obtain the feature point area (a).

10. The plant growth identification method as claimed in claim 3, wherein the plant growth identification method further comprises a step of depth calibrating the photographing unit, which is to perform the step of depth calibrating the photographing unit after the positioning photographing unit in step A, wherein the depth calibrating the photographing unit method comprises the steps of:
measuring the distance (z1) between the photographing unit and the ground with the photographing unit, tape measuring the distance (z2) between the photographing unit and the ground, and then inputting the values of the distance (z1) and distance (z2) into the photographing unit or the control unit, and after calculating the ratio of the distance (z2)/distance (z1) with the photography unit or the control unit, self-correcting the proportional error of the depth measurement of the photography unit;
or measuring the distance (z) between the photographing unit and the ground, placing a calibration label with a known height (h) on the ground, and measuring the distance (d) between the photographing unit and the calibration label by the photographing unit, and then inputting the values of the distance (z), height (h) and distance (d) into the photographing unit or the control unit, and after calculating the ratio of height (h)/(distance (z)-distance (d)) with the photographing unit or the control unit, self-correcting the proportional error of the depth measurement of the photography unit.
